(19) United States
(12) Patent Application Publication
(10) Pub. No.: US 2017/0193788 A1
(43) Pub. Date: Jul. 6, 2017

(54) AIR QUALITY NOTIFYING DEVICE CONNECTING AIR QUALITY MEASUREMENT DEVICE AND WIRELESS TERMINAL, AND AIR QUALITY NOTIFYING METHOD THEREFOR

(71) Applicant: Young Wung KIM, Buk-gu, Daegu (KR)

(72) Inventors: Young Wung KIM, Buk-gu, Daegu (KR); Seung Hyun PAIK, Gyeongsangbuk-do (KR); Jun Yeong LEE, Seo-gu, Daegu (KR); Sang Woo JUNG, Gyeongsangbuk-do (KR)

(21) Appl. No.: 15/324,983

(22) PCT Filed: Jul. 3, 2015
(86) PCT No.: PCT/KR2015/006866

§ 371 Date: Jan. 9, 2017

(30) Foreign Application Priority Data
Jul. 8, 2014 (KR) 10-2014-0085337

(51) Int. Cl. G08B 21/12; G08B 25/10; H04W 72/00; F24F 11/00

(52) U.S. Cl. CPC G08B 21/12; F24F 11/0017; G08B 25/10; H04W 72/00

(57) ABSTRACT

The present invention relates to an air quality notifying device connecting an air quality measurement device and a wireless terminal, and an air quality notifying method therefor, which can transmit, to a wireless terminal, and check a measurement value measured in a gas measuring instrument measuring the types and concentrations of various gases maintained in the atmosphere, such that ordinary people can easily recognize the measurement value by handling a measurement place and a situation suitable thereto and performing a notification function. The air quality notifying device connecting an air quality measurement device and a wireless terminal includes an air quality measurement device 10 including a gas detection sensor 11 for measuring types and content of various harmful gases distributed in the air, an environment measurement sensor 12 for respectively measuring a temperature, humidity, and fine dust of a gas measurement place, an air quality determination module 13 for deriving a measurement value by collecting and determining an air quality state in the atmosphere according to the detected gases, the content thereof, and a surrounding environment, such as the temperature, humidity, and fine dust, an air quality communication module 14 for transmitting the measurement value of an air quality that is derived through the air quality determination module 13 to an outside through communication facilities, and a notification module 15 for notifying the outside of a risk if it is measured that the measurement value of the air quality that is derived from the air quality determination module 13 is equal to or larger than a set value; and a wireless terminal 20 including a communication control module 21 for receiving the air quality measurement value by connecting, through communication, to the air quality communication module 14 of the air quality measurement device 10, air quality data 22 for storing, as a database, characteristics of the various harmful gases, the degrees of harmfulness according to the content of the harmful gases in the air, and countermeasures according to a detection place, an air quality measurement application 23 programmed to substitute the air quality measurement value that is received through the air quality measurement device 10 for a data value that is stored in the air quality data 22 so as to collect situation explanations and the countermeasures according to the substituted air quality measurement value, a display checking module 24 for displaying, so as to check, the air quality measurement value and the respective situation explanations and the countermeasures according to the air quality measurement value collected through the air quality measurement application 23, and an application operating unit 25 for selectively controlling and driving the air quality measurement application. Further, the air quality notifying method connecting an air quality measurement device and a wireless terminal includes, as successive progresses, an air quality determination step 100 including a harmful gas measurement step 110 of dividing, by types, harmful gases maintained in a measurement place through a gas detection sensor 11 in a state where the air quality measurement device 10 is maintained in the measurement place and measuring the content of the harmful gases, an environment measurement step 120 of measuring a temperature, humidity, and fine dust through an environment measurement sensor 12 provided in the air quality measurement device 10, and an air quality value deriving step 130 of deriving an air quality value by determining an air quality state in the atmosphere according to the measured harmful gases and environments; a communication connecting step 200 of selectively executing an air quality measurement application 23 that is downloaded in a wireless terminal 20 so as to connect the communication between the air quality measurement device 10 and the wireless terminal 20; an air quality value receiving step 300 of receiving, in the air quality measurement application 23 through a communication control module 21, an air quality determination value that is measured from the air quality measurement device 10 through the communication connecting step 200; an air quality value displaying step 400 of deriving, in a display checking module 24 of the wireless terminal, an air quality measurement value that is input into an air quality measurement application through the air quality value receiving step 300; an air quality value substitution step 500 of dividing the air quality value that is displayed through the air quality value displaying step 400 into respective harmful gases through an application operation unit 25 or combining the respective harmful gases into the air quality value, and substituting the air quality value in a database stored in air quality data 22; a countermeasure displaying step 600 of deriving, in the display checking module 24, countermeasures according to an air quality state in which all gases that are divided or measured according to the types and concentration of the respective gases that are substituted through the air quality value substitution step 500 are combined; a countermeasure checking step 700 of determining whether the countermeasures derived in the display checking module 24 through the countermeasure displaying step 600 have been checked; and an emergency calling step 800 of making an emergency call by another specific communication if the air quality state of the countermeasures derived through the countermeasure displaying step 600 has a value that is equal to or larger than a set value, or the air quality state that is derived through the countermeasure checking step 700 indicates a danger level, so that the air quality of the measurement place is precisely measured and the corresponding countermeasures are quickly found to solve the air quality state.

### TECHNICAL FIELD

The present invention relates to an air quality notifying device connecting an air quality measurement device and a wireless terminal and an air quality notifying method thereof, and more particularly to an air quality notifying device connecting an air quality measurement device and a wireless terminal and an air quality notifying method thereof, which can transmit, to a wireless terminal, and check a measurement value which is measured by a gas measuring instrument that measures the types and concentrations of various gases that are maintained in the atmosphere, and can enable ordinary people to easily recognize the measurement value through performing of situation measures that match a measurement place and a notification function.

### BACKGROUND ART

In the atmosphere, various gases including oxygen coexist while they are generated, maintained, and vanished, and with the development of industry, gases that are harmful to living things are abruptly generated and flow out to exert a bad influence on the human body. Accordingly, an air quality in the atmosphere may be measured by detecting gas components and distribution amounts of such harmful gases through a typical gas measuring instrument.

In general, an air quality measurement device may measure the pollution level of indoor air in a building, such as an office or a warehouse, and may display the measurement value on a display, such as a monitor, or may operate a ventilation or air conditioning system to maintain a pleasant indoor environment through discharge of indoor air or inflow of outdoor air.

That is, main pollution sources of indoor air may be formaldehyde or VOC (Volatile Organic Compounds) that comes out from construction materials and furniture, carbon monoxide or sulfurous acid gas that is generated from a stove or a gas range, microbiological materials that come out from a humidifier and a carpet, an offensive odor emitted from food wastes, and particulate matters (PM10) generated according to human activity.

Recently, as can be confirmed through Korean Patent Application Publication No. 10-2004-0013679 “Indoor air state display device” as an example to display the air pollution state, an indoor air quality display device that is applied to a living space includes a display unit 10 that is composed of a temperature display unit 12, a humidity display unit 14, and an air quality display unit 16, and a speaker 20 that outputs a voice message. In the above-described patent document, the display unit 10 for displaying the temperature, humidity, and air quality is provided, and a user can easily grasp the indoor air state.

According to the above-described patent document, the air quality display unit 16 for displaying the air quality is configured to display the measurement value that is obtained by sensing simple indoor VCO content (pollution level) through a gas sensor 38, and thus there is a limit in accurately measuring the overall main pollution sources in the office or in the living space. Further, the indoor air quality display device has the problems that it is unable to accurately measure not only particulate matters (PM10), carbon dioxide, formaldehyde, total culturable bacteria, and carbon monoxide, which are pollution sources that correspond to the maintenance standards in the domestic indoor air quality management law, but also nitrogen dioxide, VOC (Volatile Organic Compounds), and ozone, which are pollution sources that correspond to the recommendation standards. Further, the indoor air quality display device also has the problem that it is unable to accurately measure the pollution sources, and it is unable to perform measurement in any place excluding the installation place to limit its usage.

Recently, in order to provide a composite air quality measurement monitor which can minimize errors of measurement values that may occur due to heating of respective sensors so that integrated management can be performed through accurate measurement of much more main pollution sources in a corresponding place and monitoring thereof in real time, for example, Korean Utility Model Application Publication No. 20-2010-0002587 “Composite air quality measurement monitor” is disclosed, which includes a main board built in a main body case and having a control unit, a display unit, an operation unit, a signal port unit, and a transmission port unit; a sensor module connected to the signal port unit and having a plurality of sensors mounted thereon and having high heating temperatures in order; and a communication module connected to the transmission port unit to perform communication. The sensor module is configured to project from an upper portion of the main body case, and sensing sensitivity of the respective sensors against an outdoor air can be improved. The sensor module can accurately measure the main pollution sources, and transfer the measured main pollution sources to an external server or a terminal in real time through the communication module and a network, so that information on the main pollution sources can be integrally managed in each place where the measurement monitor is installed.

However, since the above-described measurement monitor performs integrated management with respect to the information on the pollution sources in a specific place or in a limited region through transmission of the variously measured air quality values only to specific partial terminals, and costs for installation or maintenance of the measurement monitor are high, the measurement monitor has been used only in a specific place or in a specific institution. Accordingly, it is not easy for the measurement monitor to detect the pollution level in a general place, such as a house in which general people reside or an office, in an atmospheric environment having a high pollution level. Further, the measurement monitor is unable to quickly cope with situations where real-time detection of various pollutants in a wide range of an atmospheric environment that is abruptly changed and proper countermeasures and solutions are required.

Accordingly, the systems that are configured as described above cannot present schemes for solving the basic requirements of general people who desires a pleasant environment in a living space through prevention or minimization of damages which are caused by not only harmful gases that are spontaneously generated but also noxious gases that are generated in industry spot even through a nation, a public institution, a related organization, or a related corporation.

### DISCLOSURE

### Technical Problem

Accordingly, the present invention has been made to solve the above-mentioned problems occurring in the related art, and one subject to be achieved by the present invention is to prevent damages due to harmful gases by measuring an air quality using a miniaturized inexpensive electronic gas sensor to which a high-performance algorithm of a low-power and low-specification embedded system is applied, transmitting the measured air quality to a typical portable terminal using wireless communication, and then notifying of countermeasures according to the air quality value that is measured through the portable terminal. In this case, ordinary people can easily recognize risks of various harmful gases that are generated in the living space through performing of situation measures that match a measurement place and a notification function.

Another subject to be achieved by the present invention is to provide an air quality notifying method for notifying general consumers of countermeasures according to the air quality measurement value through a wireless terminal to enable the consumers to live in more pleasant environments in a manner that the consumers can quickly search for the various harmful gases that are generated in various environments and their characteristics and can easily check the harmful gas content and the corresponding countermeasures.

Hereinafter, the present invention will be described in more detail with reference to the accompanying drawings.

### Technical Solution

In accordance with an aspect of the present invention, there is provided an air quality notifying device connecting an air quality measurement device and a wireless terminal, which includes an air quality measurement device 10 including a gas detection sensor 11 for measuring types and content of various harmful gases distributed in the air, an environment measurement sensor 12 for respectively measuring a temperature, humidity, and fine dust of a gas measurement place, an air quality determination module 13 for deriving a measurement value by collecting and determining an air quality state in the atmosphere according to the detected gases, the content thereof, and a surrounding environment, such as the temperature, humidity, and fine dust, an air quality communication module 14 for transmitting the measurement value of an air quality that is derived through the air quality determination module 13 to an outside through communication facilities, and a notification module 15 for notifying the outside of a risk if it is measured that the measurement value of the air quality that is derived from the air quality determination module 13 is equal to or larger than a set value; and a wireless terminal 20 including a communication control module 21 for receiving the air quality measurement value by connecting, through communication, to the air quality communication module 14 of the air quality measurement device 10, air quality data 22 for storing, as a database, characteristics of the various harmful gases, the degrees of harmfulness according to the content of the harmful gases in the air, and countermeasures according to a detection place, an air quality measurement application 23 programmed to substitute the air quality measurement value that is received through the air quality measurement device 10 for a data value that is stored in the air quality data 22 so as to collect situation explanations and the countermeasures according to the substituted air quality measurement value, a display checking module 24 for displaying, so as to check, the air quality measurement value and the respective situation explanations and the countermeasures according to the air quality measurement value collected through the air quality measurement application 23, and an application operating unit 25 for selectively controlling and driving the air quality measurement application 23.

In accordance with another aspect of the present invention, there is provided an air quality notifying method connecting an air quality measurement device and a wireless terminal, which includes, as successive progresses, an air quality determination step 100 including a harmful gas measurement step 110 of dividing, by types, harmful gases maintained in a measurement place through a gas detection sensor 11 in a state where the air quality measurement device 10 is maintained in the measurement place and measuring the content of the harmful gases, an environment measurement step 120 of measuring a temperature, humidity, and fine dust through an environment measurement sensor 12 provided in the air quality measurement device 10, and an air quality value deriving step 130 of deriving an air quality value by determining an air quality state in the atmosphere according to the measured harmful gases and environments; a communication connecting step 200 of selectively executing an air quality measurement application 23 that is downloaded in a wireless terminal 20 so as to connect the communication between the air quality measurement device 10 and the wireless terminal 20; an air quality value receiving step 300 of receiving, in the air quality measurement application 23 through a communication control module 21, an air quality determination value that is measured from the air quality measurement device 10 through the communication connecting step 200; an air quality value displaying step 400 of deriving, in a display checking module 24 of the wireless terminal, an air quality measurement value that is input into an air quality measurement application through the air quality value receiving step 300; an air quality value substitution step 500 of dividing the air quality value that is displayed through the air quality value displaying step 400 into respective harmful gases through an application operating unit 25 or combining the respective harmful gases into the air quality value, and substituting the air quality value in a database stored in air quality data 22; a countermeasure displaying step 600 of deriving, in the display checking module 24, countermeasures according to an air quality state in which all gases that are divided or measured according to the types and concentration of the respective gases that are substituted through the air quality value substitution step 500 are combined; a countermeasure checking step 700 of determining whether the countermeasures derived in the display checking module 24 through the countermeasure displaying step 600 have been checked; and an emergency calling step 800 of making an emergency call by another specific communication if the air quality state of the countermeasures derived through the countermeasure displaying step 600 has a value that is equal to or larger than a set value, or the air quality state that is derived through the countermeasure checking step 700 indicates a danger level, so that the air quality of the measurement place is precisely measured and the corresponding countermeasures are quickly found to solve the air quality state.

### Advantageous Effects

According to the air quality notifying device connecting the air quality measurement device and the wireless terminal and the air quality notifying method according to the embodiments of the present invention as described above, an accident that may occur in the living space due to the harmful gases can be prevented from occurring by enabling a resident to easily and quickly recognize the risk of the various harmful gases that are generated not only in the living space in which the resident resides but also in a visiting place through performing of the situation measures that match the measurement place and the notification function.

In addition, since the air quality notifying device and the air quality notifying method according to the embodiments of the present invention can accurately and minutely measure the types and content of the air quality that is maintained in the living space and can notify the moderns who are exposed to environment pollutions of the countermeasures that can improve the air quality in the living space, the air quality that is required to maintain the pleasant living space can be maintained, and in particular, the moderns can secure the safe life against the harmful gases through quick and easy utilization of the air quality notifying device and method.

Since the air quality notifying device and method according to the embodiments of the present invention have the advantages that they can be conveniently used in the resident environments of the moderns who desire to reside in harmless safe environments, they can be further used in and applied to not only the current resident environments but also in the future.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a diagram illustrating the configuration of an air quality notifying device according to an embodiment of the present invention;

FIG. 2 is a diagram successively illustrating an air quality notifying method according to an embodiment of the present invention;

FIG. 3 is a diagram of a display of a wireless terminal explaining an air quality value displaying step and an air quality value substitution step according to an embodiment of the present invention; and

FIG. 4 is a diagram of a display of a wireless terminal explaining a countermeasure displaying step according to an embodiment of the present invention.

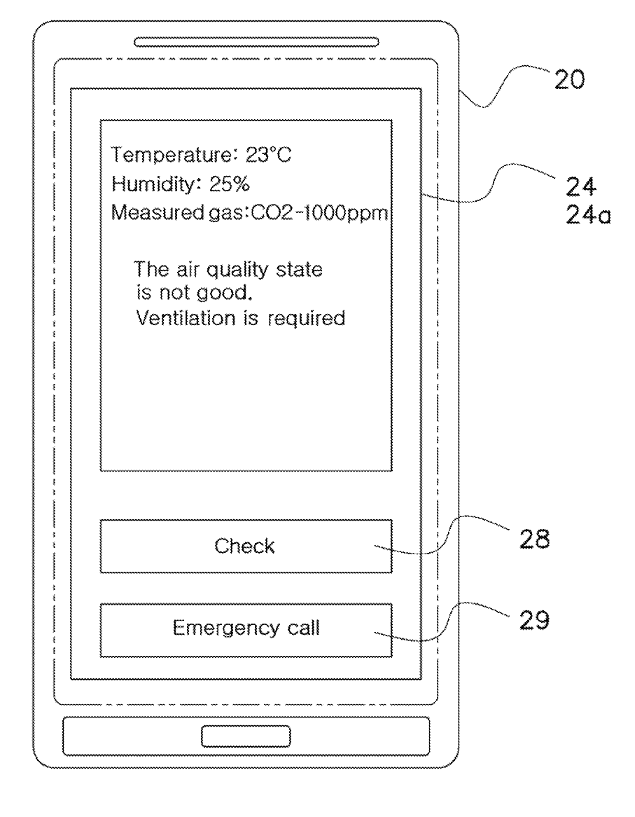

*Explanation of reference numerals for main parts in the drawing

| | |
|---|---|
| 10: air quality measurement device | 11: gas detection sensor |
| 12: environment measurement sensor | 13: air quality determination module |
| 14: air quality communication module | 15: notification module |
| 20: wireless terminal | 21: communication control unit |
| 22: air quality data | 23: air quality measurement application |
| 24: display checking unit | 24a: display unit |
| 24b: sound generation unit | 25: application operation unit |
| 30: data management device | 40: communication facility |
| 100: air quality determination step | 110: harmful gas measurement step |
| 120: environment measurement step | 130: air quality value deriving step |
| 200: communication connecting step | 300: air quality value receiving step |
| 400: air quality value displaying step | 500: air quality value substitution step |
| 600: countermeasure displaying step | 700: countermeasure checking step |
| 800: emergency calling step | |

### MODE FOR THE INVENTION

Hereinafter, preferred embodiments of the present invention will be described in detail with reference to the accompanying drawings. In explaining the present invention, detailed description of well-known technology and typical technology incorporated herein may be omitted or replaced by simple titles to avoid obscuring the subject matter of the present invention, and constituent elements having the same function will be unified into one title.

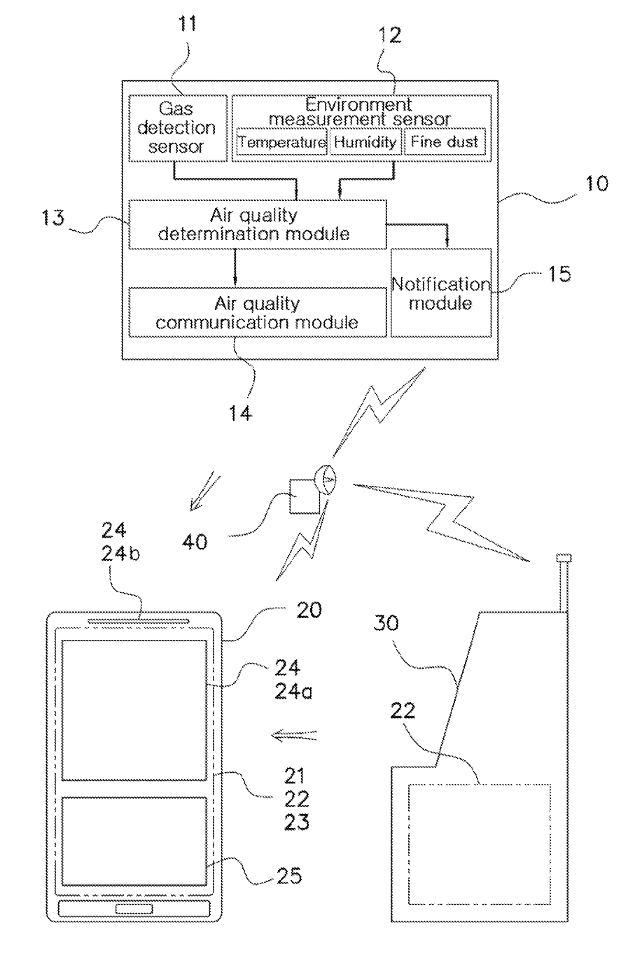

According to an embodiment of the present invention, an air quality notifying device connecting an air quality measurement device and a wireless terminal, as illustrated in FIG. 1, may include an air quality measurement device 10 including a gas detection sensor 11 for measuring types and content of various harmful gases distributed in the air, an environment measurement sensor 12 for respectively measuring a temperature, humidity, and fine dust of a gas measurement place, an air quality determination module 13 for deriving a measurement value by collecting and determining an air quality state in the atmosphere according to the detected gases, the content thereof, and a surrounding environment, such as the temperature, humidity, and fine dust, an air quality communication module 14 for transmitting the measurement value of an air quality that is derived through the air quality determination module 13 to an outside through communication facilities, and a notification module 15 for notifying the outside of a risk if it is measured that the measurement value of the air quality that is derived from the air quality determination module 13 is equal to or larger than a set value; and a wireless terminal 20 including a communication control module 21 for receiving the air quality measurement value by connecting, through communication, to the air quality communication module 14 of the air quality measurement device 10, air quality data 22 for storing, as a database, characteristics of the various harmful gases, the degrees of harmfulness according to the content of the harmful gases in the air, and countermeasures according to a detection place, an air quality measurement application 23 programmed to substitute the air quality measurement value that is received through the air quality measurement device 10 for a data value that is stored in the air quality data 22 so as to collect situation explanations and the countermeasures according to the substituted air quality measurement value, a display checking module 24 for displaying, so as to check, the air quality measurement value and the respective situation explanations and the countermeasures according to the air quality measurement value collected through the air quality measurement application 23, and an application operating unit 25 for selectively controlling and driving the air quality measurement application 23.

After the air quality measurement device 10 is put in a place in which the air quality is to be measured, the air quality measurement application 23 that is developed by an inventor of this application is downloaded to the wireless terminal 20, and the type and the content of the harmful gas that is measured by the air quality measurement device 10 are substituted in the air quality measurement application 23 to apply countermeasure schemes on the basis of the countermeasures according to the place that is stored in the air quality data 22. Accordingly, the harmful gas that is generated in the living space is quickly measured, and is easily checked through the wireless communication terminal that is generally spread without special equipment to ensure correctness of the countermeasure schemes.

In this case, it may be preferable to build the air quality data 22 in a data management device 30 that constructs a database as one hardware configuration to facilitate a management job, such as generation, modification, and deletion of the database.

As described above, the air quality notifying device may measure the air quality in a specific place through interaction of the respective constituent elements configured as described above, and may present the countermeasure according to the measured air quality. The detailed configuration and operation of the device having the respective constituent elements will now be described.

The air quality measurement device 10 may include the gas detection sensor 11 for measuring the types and content of various harmful gases distributed in the air, the environment measurement sensor 12 for respectively measuring the temperature, humidity, and fine dust of the gas measurement place, the air quality determination module 13 for deriving the measurement value by determining the air quality state in the atmosphere according to the detected gases, the content thereof, and a surrounding environment, such as the temperature, humidity, and fine dust, the air quality communication module 14 for transmitting the measurement value of the air quality that is derived through the air quality determination module 13 to an outside through communication facilities, and the notification module 15 for notifying the outside of the risk if it is measured that the measurement value of the air quality that is derived from the air quality determination module 13 is equal to or larger than the set value. Accordingly, it becomes possible to provide the small air quality measurement device 10 that has a simple precise configuration and superior quality at low costs, and thus various harmful gases, temperature, and humidity can be quickly and easily measured at the same time in various places.

That is, through the gas detection sensor 11, not only harmful gases that are distributed in the air and noxious gases that are generated through specific materials but also various harmful gases that are generated in daily life can be measured, and through the environment measurement sensor 12, the temperature, humidity, and fine dust in the place where the harmful gases are detected can be measured at the same time. The various kinds of harmful gases, although the content thereof that is distributed in the atmosphere is also important, may exert different influences on the human body according to the surrounding temperature and humidity, and thus it can be known that the above-described configurations should be applied to present more precise and accurate countermeasures.

Further, the air quality determination module 13, which derives the measurement values through determination of the air quality state in the atmosphere according to the detected gases, the content thereof, and the temperature and the humidity, is a core configuration of the air quality measurement device 10, and is provided with hardware including an integrated control board and a signal processor and software including a gas measurement algorithm and an air quality determination algorithm. The air quality determination module 13, which is the core device, may calculate the types and content of the harmful gases through substitution of the harmful gases that are detected through the gas detection sensor 11, the measured temperature, humidity, and fine dust, and all the harmful gases that are detected through the gas detection sensor 11 at the same time, may derive the result, and may determine the air quality through the air quality determination algorithm using the derived resultant value.

The air quality communication module 14 is a device that transmits the derived air quality measurement value to a portable terminal that is on the outside through typical wired or wireless communication facilities. Since the air quality communication module 14 is configured through applying of typical communication facilities 40 that adapt various known communication methods, the detailed explanation thereof will be omitted.

In addition, a power supply, which is composed of a power switch and a power supply unit to control the power that is supplied to various sensors and modules that constitute the air quality measurement device 10 according to the present invention, is a typical essential element of any electronic appliance, and thus the detailed explanation thereof will be omitted.

Further, the air quality data 22, which stores and manages, as a database, characteristics of the various harmful gases, the degrees of harmfulness according to the content of the harmful gases in the air, and countermeasures according to a detection place, is a device that divides the types of the various kinds of harmful gases that are harmful to the human body as shown as in Table 1 below, stores, as a detailed database, data of influences that the divided harmful gases exert on the human body, and checks the data through a wireless terminal to apply the checked data to the air quality that is actually measured. Further, the air quality data 22 stores, as a database, even the detailed contents exerted on the human body according to the content (concentration) of the harmful gases as shown in Table 2 and Table 3 below so as to provide the countermeasures according to the harmful gas content that is actually measured.

TABLE 1

| Corresponding gas | | Influence exerted on human body |
|---|---|---|
| Carbon dioxide (CO2) | | difficult breathing, respiratory impairment, |
| | | pulmonary function damage, headache, |
| | | mucous membrane irritation, tinnitus, |
| | | dizziness, visual impairment, and blood |
| | | pressure increase |
| Carbon monoxide (CO) | | slow metabolism, eyesight reduction, |
| | | heart and lung function impairment |
| | | (angina pectoris and bronchitis), fatigue |
| | | acceleration, physiological influences, |
| | | toxic injury, and headache (developable |
| | | to chronic headache) |
| Volatile | Benzene | stimulus, Segment, vomiting, chest pain, |
| organic | | difficult breathing, pulse irregularity, |
| compounds | | tired feeling and comatose state, sleep- |
| (VOCs) | | ing impairment, eyesight deterioration, |
| | | bleeding impairment during chronic |
| | | internal hemorrhage, liver impairment, |
| | | aplastic anemia, and leukemia |
| | Dichloro- | dizziness, nervous system damage, and |
| | benzene | tired feeling |
| | Pentachloro- | emotional instability, nerve distraction, |
| | benzene | and tired feeling |
| | Ethyl- | toxicity to nervous system |
| | benzene | |
| | Toluene | mucous membrane irritation, degreasing, |
| | | headache, dizziness, fatigue, high concen- |
| | | tration visual paralysis, loss of conscious- |
| | | ness and death, and mental distraction |
| | Xylene | growth retardation, pregnant toxicity, fetal |
| | | toxicity, toxicity to nervous system |
| | Styrene | unpleasant smell, mucous membrane |
| | | irritation, and dizziness |
| | Xylene | mucous membrane irritation, headache, |
| | | fatigue, or mental distraction |
| | Acetal- | mucous membrane irritation |
| | dehyde | |

| | |
|---|---|
| Fine dust | various kinds of respiratory diseases, cough, |
| | difficult breathing, and chest tightness |

TABLE 2
Influence exerted on human body according to CO2 concentrations

| Concentration | |
|---|---|
| (%) | Influence exerted on human body and significance |
| 0.07 | Permissive concentration in which many persons can |
| | exist in the room |
| 0.1 | Indoor ventilation reference concentration, permissible |
| | concentration in a normal case |
| 0.2~0.5 | Considerably bad state, 0.5% is based on TWA. |
| 2~3 | Increase of breath rate, unpleasant feeling, partial |
| | toxic action, and 3% is based on STEL. |
| 4~5 | Headache, mucous membrane irritation, dizziness, |
| | blood pressure increase, respiratory center stimulus, |
| | danger in case of continuous inhalation |
| 8 | Very difficult breathing after respiration for 10 |
| | minutes, facial flushing, headache, and vomiting |
| 10~25 | Visual impairment, blood pressure increase, paralysis, |
| | and loss of consciousness |
| 25% or more | Central nervous system depression, paralysis, and |
| | suffocation death |

TABLE 3
Influence exerted on human body according to CO concentrations

| Concentration | |
|---|---|
| (ppm) | Influence exerted on human body and significance |
| 9 | Reflex changes of nervous system, exposure |
| | reference concentration of resident area |
| 30 | TWA exposure reference concentration |
| 100 | Function loss of 10% of blood in the body in case |
| | of continuation over three hours |
| 200 | Headache, fatigue, malaise, dizziness, nauseating, |
| | STEL exposure basis |
| 300 | Visual and mental function impairment in case of |
| | exposure over 8 hours |
| 500 | Headache, visual impairment, despondency, and |
| | listlessness |
| 800 | Dizziness, nauseating, convulsions, loss of conscious- |
| | ness within two hours |
| 1600 | Death within one hour |

In addition, it may be preferable to build the air quality data 22 in the data management device 30 that constructs a database together with the air quality measurement application 23 as one hardware configuration to facilitate a management job, such as generation, modification, and deletion of the database.

That is, since the air quality data 22, which stores and manages, as a database, the characteristics of various kinds of harmful gases, the degrees of harmfulness according to the content of the harmful gases in the air, and the countermeasures according to a detection place, should be managed as the database through jobs in which an operator should record one by one, correct, modify, or delete, if necessary, basic information of various kinds of information, such as the characteristics of the various kinds of harmful gases and the influences exerted on the human body, the air quality data 22 can be downloaded together when the air quality measurement application 23 that is developed by an inventor of this application is downloaded to the wireless terminal, in a state where it is built in the data management device 30 that is constructed as one hardware configuration, and can be used to configure the air quality notifying device connecting the air quality measurement device and the wireless terminal.

The wireless terminal 20 may include the communication control module 21 for receiving a download of the air quality measurement application 23 that is developed by an inventor of this application from the data management device 30 and receiving the air quality measurement value that is transmitted from the air quality measurement device 10 by connecting, through communication, to the air quality communication module 14 of the air quality measurement device 10; the air quality data 22 for storing, as a database, the characteristics of the various harmful gases, the degrees of harmfulness according to the content of the harmful gases in the air, and the countermeasures according to the detection place; the air quality measurement application 23 programmed to substitute the air quality measurement value that is received through the air quality measurement device 10 for a data value that is stored in the air quality data 22 so as to collect situation explanations and the countermeasures according to the substituted air quality measurement value; the display checking module 24 for displaying, so as to check, the air quality measurement value that is collected through the air quality measurement application 23 and the respective situation explanations and the countermeasures according to the air quality measurement value; and the application operating unit 25 for selectively controlling and driving the air quality measurement application 23.

Accordingly, in a place where the air quality measurement device 10 is provided, the air quality measurement application 23 that is built in the wireless terminal 20 is driven to substitute the type and the content of the harmful gas that is measured by the air quality measurement device 10 in the air quality measurement application 23, and to apply the countermeasure schemes on the basis of the countermeasures according to the place that is stored in the air quality data 22. Accordingly, the harmful gas that is generated in the living space is quickly measured, and is easily checked through the wireless communication terminal that is generally spread without special equipment to ensure correctness of the countermeasure schemes.

That is, the air quality measurement application 23, which is programmed to substitute the air quality measurement value that is received through the air quality measurement device 10 for the data value that is stored in the air quality data 22 so as to collect the situation explanations and the countermeasures according to the substituted air quality measurement value, is downloaded in the typical wireless terminal 20, and thus the wireless terminal 20 can be used as the air quality notifying device that derives the air quality measurement value and the corresponding countermeasures. The core constituent elements are the display checking module 24 for displaying the air quality measurement value and the respective situation explanations and the countermeasures according to the air quality measurement value so that a user can easily check the same, and the application operating unit 25 for selectively controlling and driving the air quality measurement application 23.

In this case, the display checking module 24 may be configured to include a display unit 24a for displaying, so as to check with the naked eye, the air quality measurement value and the respective situation explanations and the countermeasures according to the air quality measurement value that are collected through the air quality measurement application 23, and a sound generation unit 24b for aurally checking the air quality measurement value and the respective situation explanations and the countermeasures according to the air quality measurement value.

That is, the display unit 24a and the sound generation unit 24b are configurations to expose the air quality that is measured through the air quality measurement device 10 to an outside so that a user can easily recognize the air quality, and may be implemented by a display and a sound device that are provided on the typical wireless terminal. Further, the application operating unit 25 is a constituent element that is generated by the air quality measurement application 23 and is displayed on the display of the typical wireless terminal to substitute the measurement values of the corresponding gases that are measured by the air quality measurement device 10 or the measurement values of all the measured harmful gases in the database that is provided in the data management device 30.

The detailed processes, which are performed by respective steps that are successively performed through the air quality measurement device for performing an air quality measurement method that includes successive displaying and checking steps for measuring an air quality in a specific place and presents countermeasures according to the measured air quality and an air quality notifying method for deriving the countermeasures, are as follows.

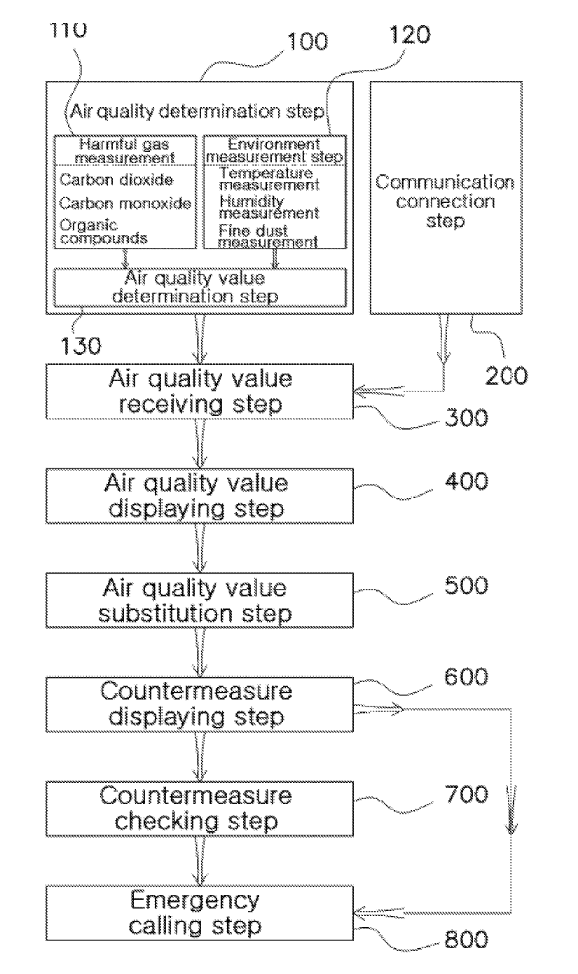

An air quality notifying method connecting an air quality measurement device and a wireless terminal, which is performed through the air quality notifying device connecting the air quality measurement device and the wireless terminal, as illustrated in FIG. 2, may include, as successive progresses, an air quality determination step 100 including a harmful gas measurement step 110 of dividing, by types, harmful gases maintained in a measurement place through a gas detection sensor 11 in a state where the air quality measurement device 10 is maintained in the measurement place and measuring the content of the harmful gases, an environment measurement step 120 of measuring a temperature, humidity, and fine dust through an environment measurement sensor 12 provided in the air quality measurement device 10, and an air quality value deriving step 130 of deriving an air quality value by determining an air quality state in the atmosphere according to the measured harmful gases and environments; a communication connecting step 200 of selectively executing an air quality measurement application 23 that is downloaded in a wireless terminal 20 so as to connect the communication between the air quality measurement device 10 and the wireless terminal 20; an air quality value receiving step 300 of receiving, in the air quality measurement application 23 through a communication control module 21, an air quality determination value that is measured from the air quality measurement device 10 through the communication connecting step 200; an air quality value displaying step 400 of deriving, in a display checking module 24 of the wireless terminal, an air quality measurement value that is input into an air quality measurement application through the air quality value receiving step 300; an air quality value substitution step 500 of dividing the air quality value that is displayed through the air quality value displaying step 400 into respective harmful gases through an application operating unit 25 or combining the respective harmful gases into the air quality value, and substituting the air quality value in a database stored in air quality data 22; a countermeasure displaying step 600 of deriving, in the display checking module 24, countermeasures according to an air quality state in which all gases that are divided or measured according to the types and concentration of the respective gases that are substituted through the air quality value substitution step 500 are combined; a countermeasure checking step 700 of determining whether the countermeasures derived in the display checking module 24 through the countermeasure displaying step 600 have been checked; and an emergency calling step 800 of making an emergency call by another specific communication if the air quality state of the countermeasures derived through the countermeasure displaying step 600 has a value that is equal to or larger than a set value, or the air quality state that is derived through the countermeasure checking step 700 indicates a danger level, so that the air quality of the measurement place is precisely measured and the corresponding countermeasures are quickly found to solve the air quality state.

In the air quality determination step 100, it is preferable that the gas detection sensor 11 and the environment measurement sensor 12 operate, through a power supply thereto after the air quality measurement device 10 is put in a measurement place in which harmful gases are to be measured, to sufficiently measure the harmful gases contained in the space and various kinds of environment information, such as a temperature, humidity, and fine dust. The air quality determination step 100 is a core element and an important step according to the present invention, in which the harmful gases that are distributed in the air are divided by types, the content of each of the harmful gases is precisely measured, and then an air quality value is derived through mutual substitution of the measured harmful gas and the measurement environment.

Further, in the communication connection step 200 in which the communication is connected between the air quality measurement device 10 and the wireless terminal 20 through execution of the air quality measurement application 23 that is downloaded in the wireless terminal 20, after selecting and executing the air quality measurement application 23 that is downloaded in the wireless terminal 20, a proceeding region of the application operating unit 25 that appears on the display is clicked to connect communication with the air quality communication module 14 of the air quality measurement device 10, and the communication connection state is displayed in a yes/no manner on the display screen of the wireless terminal 20 of which the communication connection has been completed. As illustrated in FIG. 1, it may be preferable that a wireless communication using known communication facilities or Bluetooth is used as the communication method, but is not limited thereto. The communication connection step 200 may be performed even using a typical wire connection.

Further, in the air quality value receiving step 300 of receiving, in the air quality measurement application 23 of the wireless terminal through the communication connection step 200, the air quality value that is measured from the air quality measurement device 10, the air quality value that is measured by the air quality measurement device 10 is accurately and quickly transmitted to the air quality communication module 14 through the communication control module 21, and then is received in the air quality measurement application 23 of the wireless terminal 20 that has performed the communication connection step 200 through the download of the air quality measurement application 23.

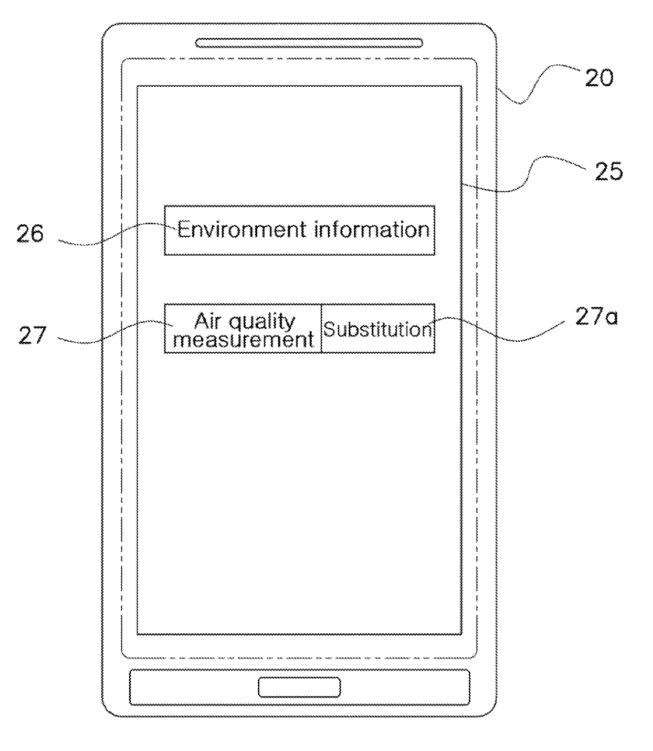

Further, in the air quality value displaying step 400 of deriving, in the display checking module 24 of the wireless terminal 20 that is divided into the display unit 24a and the sound generation unit 24b, the air quality measurement value that is input into the air quality measurement application 23 through the air quality value receiving step 300, as exemplarily illustrated in FIG. 3, the application adjustment unit 25 of the wireless terminal 20 is divided into an environment information region 26 and an air quality measurement region 27. In this case, it is preferable that the temperature, humidity, and fine dust, which are measured by the air quality measurement device 10, can be directly checked through the environment information region 26, and weather information according to areas can be indirectly checked through another weather related application. Further, it is preferable that the air quality measurement value that is detected and measured through the air quality measurement device 10 can be minutely displayed for checking through the air quality measurement region 27, and if necessary, the environment information and the air quality measurement value can be displayed on one display screen at a time.

In particular, it is preferable that harmful gas that is indicated as the air quality measurement value that is equal to or larger than the WTA reference value is separately displayed to notify in emphasis that the air quality of the measurement place exerts a direct influence on the human body, and if necessary, corresponding sound may be output through the sound generation unit 24b of the wireless terminal 20.

In addition, in the air quality value substitution step 500 of dividing the air quality value that is displayed through the air quality value displaying step 400 into respective harmful gases that are measured through the application operating unit 25 or combining the respective harmful gases and substituting the air quality value in the database stored in the air quality data 22, as illustrated in FIG. 3, an air quality substation region 27 that appears at the air quality value displaying step 400 is clicked to individually set and substitute the respective harmful gases that are measured through the application operating unit 25 among the air quality values that are detected and measured through the air quality measurement device 10 in the region, or if necessary, the plural harmful gases that are individually set are substituted therein at a time to check the countermeasures to the measured air quality values.

In the countermeasure displaying step 600 of deriving, in the display checking module 24 that is divided into the display unit 24a and the sound generation unit 24b, the countermeasures according to the air quality state in which all the gases that are divided or measured according to the types and concentration of the respective gases that are substituted through the air quality value substitution step 500 are combined, as illustrated in FIG. 3, an air quality substitution region 27a of the air quality value substitution step 500 is clicked to display the countermeasures cited in the database that is secured in the air quality data 22 in the display unit 24a of the user's wireless terminal 20 that uses the air quality measurement device 10, and thus the countermeasures according to the concentration of the harmful gas that is harmful to the human body, which are suitable to the air quality measurement place, are presented to even slightly reduce the injury that may be caused by the harmful gas that is exposed during the daily life.

In addition, in the countermeasure checking step 700 of determining whether the countermeasures derived in the display unit 24a of the wireless terminal 20 through the countermeasure displaying step 600 have been checked, a user may determine whether to check the countermeasures that are derived in the display unit 24a, and in this case, a checking region 28 of the application operating unit 25 is clicked to determine the checking and to grasp the air quality value that is measured by the user. If a button of the checking region 28 is not pressed for a predetermined time, the countermeasure displaying step 600 is ended, or the emergency calling step 800 is automatically performed.

Further, in the emergency calling step 800 of making an emergency call by another predetermined communication if the air quality state of the countermeasures derived through the countermeasure displaying step 600 has a value that is equal to or larger than the set value, or the air quality state that is derived through the countermeasure checking step 700 indicates a danger level, an emergency call region 29 is clicked to make the emergency call by the other predetermined communication in the case where the harmful gas that is measured through the air quality measurement device 10 according to the present invention is measured enough to exert a direct influence on the human body in a short time. If it is considered that the air quality measurement value is very large, and there is a risk of safety accident occurrence even in the case where a user does not click the emergency call region 29, the emergency call is made to safety countermeasures headquarters, a district fire department, or a predetermined call number according to predetermined harmful gas types and content to notify the outside of the risk, so that the safety accident can be prevented from occurring and the corresponding countermeasures can be quickly taken.

FIG. 2 is a diagram successively illustrating the air quality notifying method according to an embodiment of the present invention, and through this, an air quality notification method according to an embodiment of the present invention will be described in detail. However, such an embodiment is presented only to help understanding of the present invention, and the scope of the present invention is not limited thereto.

### Example 1) Interior of a Subway Vehicle

In a state where the air quality measurement device 10 is equipped in a subway vehicle, carbon dioxide was measured as in Table 4 below through the air quality notifying device connecting the air quality measurement device and the wireless terminal and the air quality notifying method according to the present invention at rush hours.

TABLE 4

| | Concentration | Temperature | Humidity |
|---|---|---|---|
| Detected gas | (ppm) | (° C.) | (%) |
| Carbon dioxide (CO2) | 3000 | 23 | 50 |

The air quality in the subway vehicle deteriorates greatly depending on the number of passengers. In particular, at rush hours, the air quality deteriorates greatly due to an abrupt increase of CO2 concentrations (maximally increased up to 5000 ppm according to Seoul subway air quality statistical data), and this situation may easily exerts a bad influence on not only general healthy passengers but also health-vulnerable passengers (old persons or babies and children). Through installation of the air quality measurement device in the subway vehicle, a vehicle conductor can check the air quality state in real time, and if the air quality deteriorates to the extent of the legal recommendation standard or enough to be harmful to the human body, the conductor can improve the air quality with reference to the air quality countermeasure application recommendations (e.g., “Open the doors for a longer time for ventilation at a stop. Make a proposal to a person in charge).

### Example 2) Interior of a Tent in a Camping Area or Bivouac Area

In a state where the air quality measurement device 10 is equipped in a tent in a camping area or bivouac area, carbon monoxide was measured as in Table 5 blow through the air quality notifying device connecting the air quality measurement device and the wireless terminal and the air quality notifying method according to the present invention at rush hours.

TABLE 5

| | Concentration | Temperature | Humidity |
|---|---|---|---|
| Detected gas | (ppm) | (° C.) | (%) |
| Carbon monoxide (CO) | 1000 | 23 | 50 |

After using a charcoal or butane gas heater for heating in the camping area or bivouac area, a user operates the air quality measurement device before going to bed. If CO gas leaks out due to malfunction or partial breakage of the heater, the wireless terminal notifies (alarms) of the current indoor air quality situation, and displays countermeasure recommendations (Ventilation is necessary in the tent. Immediately go out and breathe fresh air). The user copes with the situation so as not to be injured by the air quality with reference to the countermeasures.

As described above through the above-described examples, the environments in which the moderns live are exposed to various environmental pollutions, such as various kinds of harmful gases and fine dust. According to the air quality notifying device connecting the air quality measurement device and the wireless terminal and the air quality notifying method according to the embodiments of the present invention, an accident that may occur in the living space due to the harmful gases can be prevented from occurring by enabling a resident to easily and quickly recognize the risk of the various harmful gases that are generated not only in the living space in which the resident resides but also in a visiting place through performing of the situation measures that match the measurement place and the notification function. In addition, since the air quality notifying device and the air quality notifying method according to the embodiments of the present invention can accurately and minutely measure the types and content of the air quality that is maintained in the living space and can notify the moderns who are exposed to environment pollutions of the countermeasures that can improve the air quality in the living space, the air quality that is required to maintain the pleasant living space can be maintained, and in particular, the moderns can secure the safe life against the harmful gases through quick and easy utilization of the air quality notifying device and method. Since the air quality notifying device and method according to the embodiments of the present invention have the advantages that they can be conveniently used in the resident environments of the moderns who desire to reside in harmless safe environments, they can be further used in and applied to not only the current resident environments but also in the future.

Although the present invention has been described with reference to the preferred embodiments in the attached figures, it is to be understood that various equivalent modifications and variations of the embodiment can be made by a person having an ordinary skill in the art without departing from the spirit and scope of the present invention.

What is claimed is:

1. An air quality notifying device connecting an air quality measurement device and a wireless terminal, comprising:
an air quality measurement device 10 including a gas detection sensor 11 for measuring types and content of various harmful gases distributed in the air, an environment measurement sensor 12 for respectively measuring a temperature, humidity, and fine dust of a gas measurement place, an air quality determination module 13 for deriving a measurement value by collecting and determining an air quality state in the atmosphere according to the detected gases, the content thereof, and a surrounding environment, such as the temperature, humidity, and fine dust, an air quality communication module 14 for transmitting the measurement value of an air quality that is derived through the air quality determination module 13 to an outside through communication facilities, and a notification module 15 for notifying the outside of a risk if it is measured that the measurement value of the air quality that is derived from the air quality determination module 13 is equal to or larger than a set value;
a wireless terminal 20 including a communication control module 21 for receiving the air quality measurement value by connecting, through communication, to the air quality communication module 14 of the air quality measurement device 10, air quality data 22 for storing, as a database, characteristics of the various harmful gases, the degrees of harmfulness according to the content of the harmful gases in the air, and countermeasures according to a detection place, an air quality measurement application 23 programmed to substitute the air quality measurement value that is received through the air quality measurement device 10 for a data value that is stored in the air quality data 22 so as to collect situation explanations and the countermeasures according to the substituted air quality measurement value, a display checking module 24 including a display unit 24a for displaying, so as to check with the naked eye, the air quality measurement value and the respective situation explanations and the countermeasures according to the air quality measurement value collected through the air quality measurement application 23, or a sound generation unit 24b for aurally checking the air quality measurement value and the respective situation explanations and the countermeasures according to the air quality measurement value, and an application operating unit 25 for selectively controlling and driving the air quality measurement application 23; and
a data management device 30 for constructing a database of the air quality data 22 for storing, as a database, the characteristics of the various harmful gases, the degrees of harmfulness according to the content of the harmful gases in the air, and the countermeasures according to the detection place, as one hardware configuration to facilitate a management job, such as generation, modification, and deletion of the database.

2. An air quality notifying method connecting an air quality measurement device and a wireless terminal, comprising, as successive progresses:
an air quality determination step 100 including a harmful gas measurement step 110 of dividing, by types, harmful gases maintained in a measurement place through a gas detection sensor 11 in a state where the air quality measurement device 10 is maintained in the measurement place and measuring the content of the harmful gases, an environment measurement step 120 of measuring a temperature, humidity, and fine dust through an environment measurement sensor 12 provided in the air quality measurement device 10, and an air quality value deriving step 130 of deriving an air quality value by determining an air quality state in the atmosphere according to the measured harmful gases and environments;
a communication connecting step 200 of selectively executing an air quality measurement application 23 that is downloaded in a wireless terminal 20 so as to connect the communication between the air quality measurement device 10 and the wireless terminal 20;
an air quality value receiving step 300 of receiving, in the air quality measurement application 23 through a communication control module 21, an air quality determination value that is measured from the air quality measurement device 10 through the communication connecting step 200;
an air quality value displaying step 400 of deriving, in a display checking module 24 of the wireless terminal, an air quality measurement value that is input into an air quality measurement application through the air quality value receiving step 300;
an air quality value substitution step 500 of dividing the air quality value that is displayed through the air quality value displaying step 400 into respective harmful gases through an application operation unit 25 or combining the respective harmful gases into the air quality value, and substituting the air quality value in a database stored in air quality data 22;
a countermeasure displaying step 600 of deriving, in the display checking module 24, countermeasures according to an air quality state in which all gases that are divided or measured according to the types and concentration of the respective gases that are substituted through the air quality value substitution step 500 are combined;
a countermeasure checking step 700 of determining whether the countermeasures derived in the display checking module 24 through the countermeasure displaying step 600 have been checked; and
an emergency calling step 800 of making an emergency call to safety countermeasures headquarters, a district fire department, or a predetermined call number according to predetermined harmful gas types and content if the air quality state of the countermeasures that is derived through the countermeasure displaying step 600 has a value that is equal to or larger than a set value, or the air quality state that is derived through the countermeasure checking step 700 indicates a danger level,
wherein the above-described steps are successively performed.
